(19) United States
(12) Patent Application Publication
(10) Pub. No.: US 2006/0224687 A1
(43) Pub. Date: Oct. 5, 2006

(54) Method and apparatus for offline cooperative file distribution using cache nodes

(76) Inventors: Laird Alexander Popkin, West Orange, NJ (US); Yariv Sadan, Tenafly, NJ (US); Yaron Samid, New York, NY (US)

Correspondence Address: Ryan, Mason & Lewis, LLP, Suite 205, 1300 Post Road, Fairfield, CT, 06824, US

(21) Appl. No.: 11/096,193

(22) Filed: Mar. 31, 2005

(51) Int. Cl. G06F 15/16

(52) U.S. Cl. 709/217

(57) ABSTRACT

Methods and apparatus are provided for cooperative file distribution system employing one or more storage proxies to allow an offline receiver to obtain files or pieces thereof when the receiver comes online. A central tracker receives an indication from the sender that the sender has the file; determines if the receiver is online; and initiates a storage of the file on one or more storage proxies if the receiver is not online. A proxy service can identify one or more potential storage proxies that can store the file and that each satisfy one or more predefined resource criteria. The sender can send a request to one or more of the storage proxies from the list of storage proxies to act as a storage proxy for the communication between the sender and the receiver. The potential storage proxies compare one or more resource measures to predefined criteria; and provide an acceptance if the one or more resource measures satisfy the predefined criteria.

### CROSS REFERENCE TO RELATED APPLICATIONS

The present application is related to U.S. patent application Ser. No. ______, entitled “Method and Apparatus for Cooperative File Distribution in the Presence of Firewalls,” filed contemporaneously herewith and incorporated by reference herein.

### FIELD OF THE INVENTION

The present invention relates generally to communication methods and systems, and more particularly, to cooperative methods and systems for sharing one or more files among users.

### BACKGROUND OF THE INVENTION

7The providers of popular, large digital files, such as software, music or video files, must keep pace with the ever increasing bandwidth demands for delivering such files. As the popularity of a file increases, a larger number of users are requesting the file and more bandwidth is required to deliver the file. With conventional Hypertext Transfer Protocol (HTTP) file delivery techniques, for example, the bandwidth requirements increase linearly with the number of requesting users, and quickly becomes prohibitively expensive.

A number of techniques have been proposed or suggested for reducing the bandwidth demands of file delivery on the server, using peer-to-peer content sharing. In a peer-to-peer content sharing model, often referred to as “cooperative distribution,” one or more users that have downloaded a file from the server can share the file with other users. A cooperative distribution model allows a server to deliver large files in a reliable manner that scales with the number of requesting users. Among other benefits, cooperative distribution models exploit the underutilized upstream bandwidth of existing users.

The BitTorrent™ file distribution system, described, for example, in http://www.bittorrent.com/documentation.html, or Bram Cohen, “Incentives Build Robustness in BitTorrent,” http://www.bittorrent.com/bittorrentecon.pdf (May 22, 2003) is an example of a cooperative distribution technique. When multiple users are downloading the same file at the same time using the BitTorrent file distribution system, the various users upload pieces of the file to each other. In other words, a BitTorrent user trades pieces of a file that the user has with other required pieces that other users have until the complete file is obtained. In this manner, the cost of uploading a file is redistributed to the users of the file and the cost of hosting a popular file is more affordable.

While the BitTorrent file distribution system provides an effective mechanism for distributing large files in a cost effective manner, it suffers from a number of limitations, which if overcome, could further improve the utility and efficiency of cooperative file distribution. In particular, if a BitTorrent receiver is offline, then the receiver is unable to obtain files from other users.

A need therefore exists for a cooperative file distribution system that allows files or pieces thereof to be cached on one or more storage proxies for subsequent delivery to an offline recipient. A further need exists for a cooperative file distribution system that employs one or more storage proxies to allow an offline receiver to obtain files or pieces thereof when the receiver comes online.

### SUMMARY OF THE INVENTION

Generally, methods and apparatus are provided for cooperative file distribution system employing one or more storage proxies to allow an offline receiver to obtain files or pieces thereof when the receiver comes online. According to one aspect of the invention, a central tracker receives an indication from the sender that the sender has the file; determines if the receiver is online; and initiates a storage of the file on one or more storage proxies if the receiver is not online. The central tracker can obtain a list, for example, from a proxy service, of potential storage proxies for transferring the file from the sender to the receiver and initiate a transfer of the file from the sender to the receiver using one or more of the potential storage proxies. The proxy service identifies one or more storage proxies that can store the file while the receiver is unavailable and satisfy one or more predefined resource criteria; and provides a list of potential storage proxies for transferring the file from the sender to the receiver.

According to another aspect of the invention, the sender sends an indication to a central tracker that the sender has the file; receives a list of potential storage proxies for storing the file while the receiver is unavailable; sends a request to one or more of the storage proxies from the list of storage proxies to act as a storage proxy between the sender and the receiver; and transfers the file to the one or more of the potential storage proxies.

The potential storage proxies receive requests to act as a storage proxy for storing the file while the receiver is unavailable; compare one or more resource measures to predefined criteria; and provide an acceptance if the one or more resource measures satisfy the predefined criteria.

A receiver in accordance with the present invention sends a connection message to a central tracker to obtain the file; receives a notification of one or more storage proxies that stored at least a portion of the file while the receiver was unavailable; and obtains the at least a portion of the file from the one or more storage proxies.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram illustrating a conventional BitTorrent file distribution system;

FIG. 2 is a schematic block diagram of a cooperative file distribution system incorporating features of the present invention;

FIG. 3 is a communication sequence diagram in accordance with a Unified Modeling Language (UML) notation, illustrating the communications and other processing performed by the various entities of FIG. 2;

FIG. 4 is a communication sequence diagram in accordance with UML notation, illustrating exemplary communications between the master storage proxy and one or more slave storage proxies;

FIG. 5 is a communication sequence diagram in accordance with UML notation, illustrating exemplary communications between the master storage proxy and one or more slave storage proxies for persistent storage of a file or a piece thereof;

FIG. 6 is a communication sequence diagram illustrating exemplary communications between the master storage proxy and one or more slave storage proxies for mutual monitoring and recreation of data in the event that one or more storage proxies becomes unavailable;

FIG. 7 is a flow chart describing an exemplary implementation of a bit torrent initiation process, as performed by the offline routing tracker of FIG. 2; and

FIG. 8 is a flow chart describing an exemplary implementation of a storage proxy selection process, as performed by the proxy service of FIG. 2.

### DETAILED DESCRIPTION

The present invention provides a cooperative file distribution system that employs one or more storage proxies to allow an offline receiver to obtain files or pieces thereof when the receiver comes online.

### BitTorrent Framework

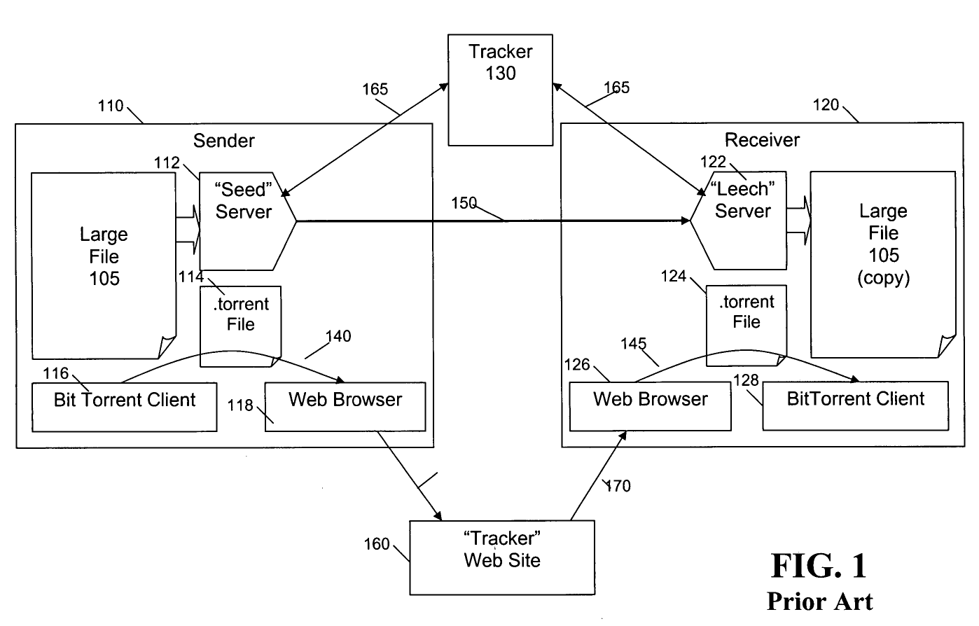

FIG. 1 is a schematic block diagram illustrating a conventional BitTorrent file distribution system 100. As shown in FIG. 1, a sender 110, desiring to send one or more large files 105 to a receiver 120, interacts with a tracker 130 that is part of the BitTorrent file distribution system 100. For a more detailed discussion of the BitTorrent file distribution system 100, see, for example, BitTorrent Protocol, http://www.bittorrent.com/protocol.html, or BitTorrent Guide, http://www.bittorrent.com/guide.html, each incorporated by reference herein.

Generally, to publish one or more files 105 using the BitTorrent file distribution system 100, a corresponding static file 114 with extension torrent is put on a web server 160. In particular, as shown in FIG. 1, a BitTorrent client 116 executing on the sender computing device 110 typically initiates a web browser 118, for example, via a manual post 140, to place the torrent file 114 on the BitTorrent web server 160. Alternatively, the torrent file 114 can be sent by email to the receiver 120. The web browser 118 communicates with the BitTorrent web server 160, for example, by means of conventional HTTP communications 170. The .torrent file 114 contains information about the file, including its length, name, and hashing information, and the web address (e.g., a URL) of a tracker 130. Trackers 130 are responsible for helping users find each other.

Trackers 130 communicate using a protocol that may be layered on top of HTTP in which a downloader 110, 120 sends information regarding the one or more files that the user is downloading, the port that the user is listening on, and similar information, and the tracker 130 responds with a list of contact information for peers that are downloading the same file. Downloaders 110, 120 then use this information to connect with one another.

To make one or more files 105 available, a downloader 110 having the complete file(s) 105 initiates a seed server 112, using the BitTorrent client 116. The bandwidth requirements of the tracker 130 and web server 160 are low, while the seed must send out at least one complete copy of the original file.

The responsibilities of the tracker 130 are generally limited to helping peers (i.e., users) find each other. Typically, the tracker 130 returns a random list of peers to each user. In order to keep track of the files and file pieces held by each user 110, 120, the BitTorrent file distribution system 100 divides files into pieces of fixed size, typically a quarter megabyte. Each downloader 110, 120 reports to all of its peers via the tracker 130, the pieces held by the respective downloader 110, 120. Generally, each peer sends bit torrent tracker messages 165 to the tracker 130. To verify data integrity, a hash of each piece can be included in the .torrent file 114, and a given peer does not report that it has a given piece until the corresponding hash has been validated.

On the receiver side 120, the receiver 120 reads the web page on the tracker web site 160 with .torrent file 114 attached and uses the browser 126 to click on the .torrent file. As a result, the BitTorrent client 128 is launched on the receiver 120 and the .torrent file 124 is provided to the client process 128. In addition, the BitTorrent client 128 initiates a “Leech” server 122 that allows the receiver 120 to connect to the public tracker 130. In this manner, the file 105 is sent from the “seed” 112 to the “leech” 122 via connection 150, such as an offline peer-to-peer connection or swarm delivery, in a known manner. The file copy 105 can then be opened by the receiver 120, for example, using an operating system function.

### Cooperative File Distribution Around Firewall(s)

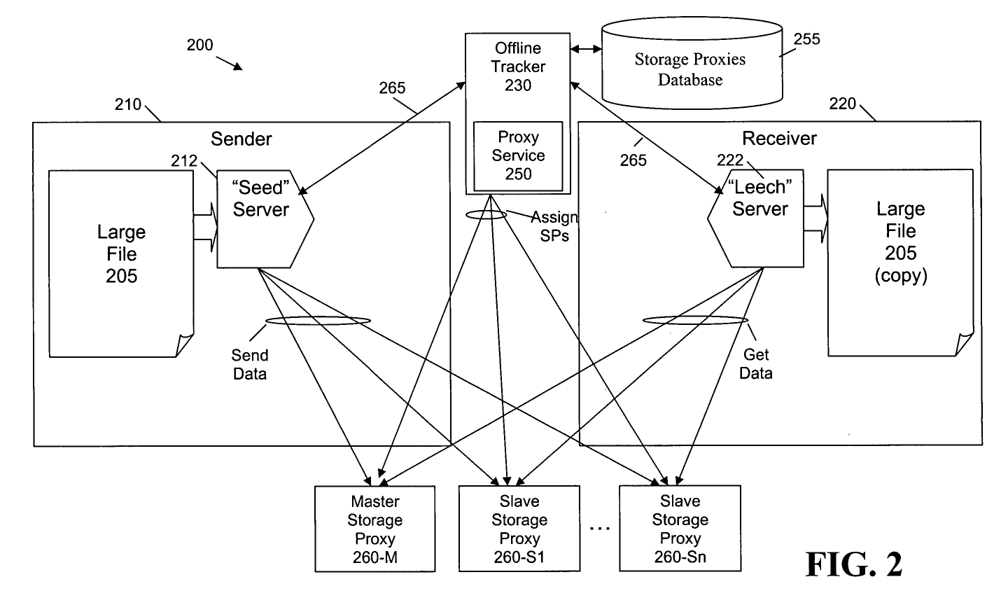

As previously indicated, if a BitTorrent receiver is offline, then the receiver is unable to share files with other users. The present invention provides a cooperative file distribution system 200, shown in FIG. 2, that employs one or more storage proxies 260-1 through 260-n (hereinafter, collectively referred to as storage proxies 260) to allow an offline receiver to obtain files or pieces thereof when the receiver comes online.

FIG. 2 is a schematic block diagram of a cooperative file distribution system 200 incorporating features of the present invention. The present invention thus uses storage nodes 260 to cache communications between two nodes 210, 220. The sender 210 deposits blocks of data into the proxy nodes 260 for subsequent retrieval by the receiver 220, and the receiver 220 can thereafter retrieve that data from the storage proxies 260. In one exemplary implementation, each piece of a file is broken into multiple, incomplete streams of data, so that no one storage proxy 260 contains a complete piece of the original data. Generally, the source data from the file 205 can be recreated only by combining data from each storage proxy 260.

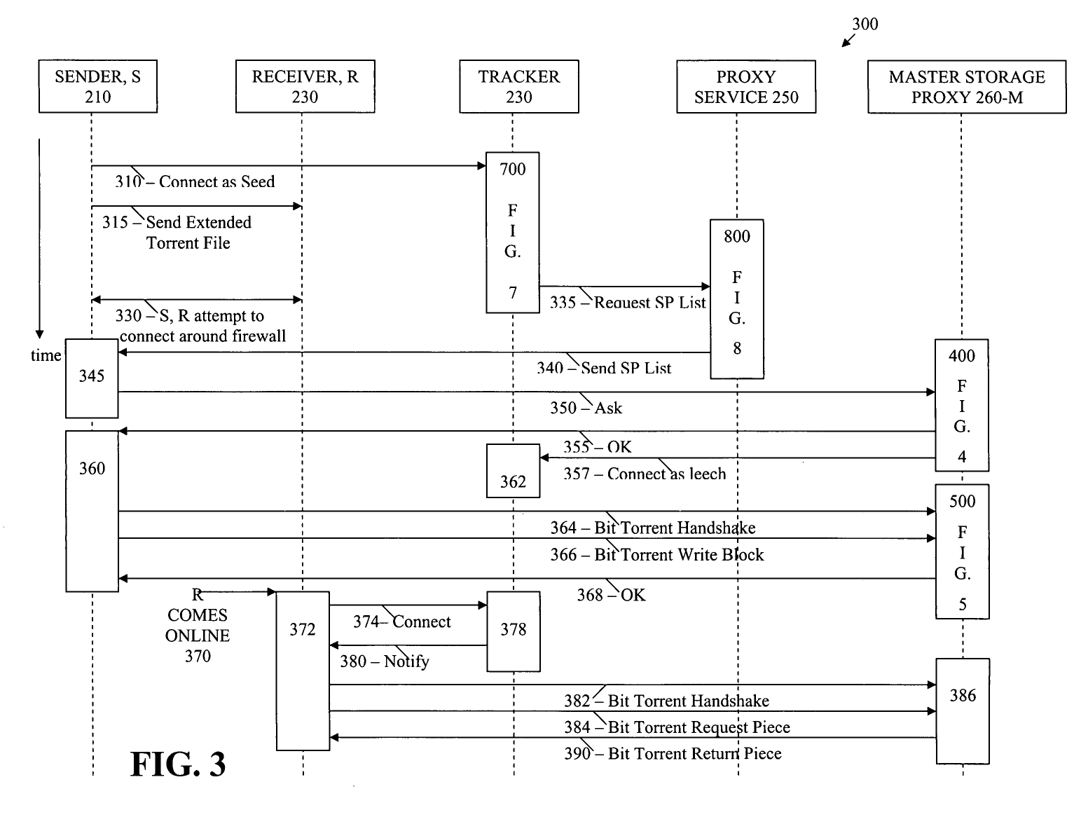

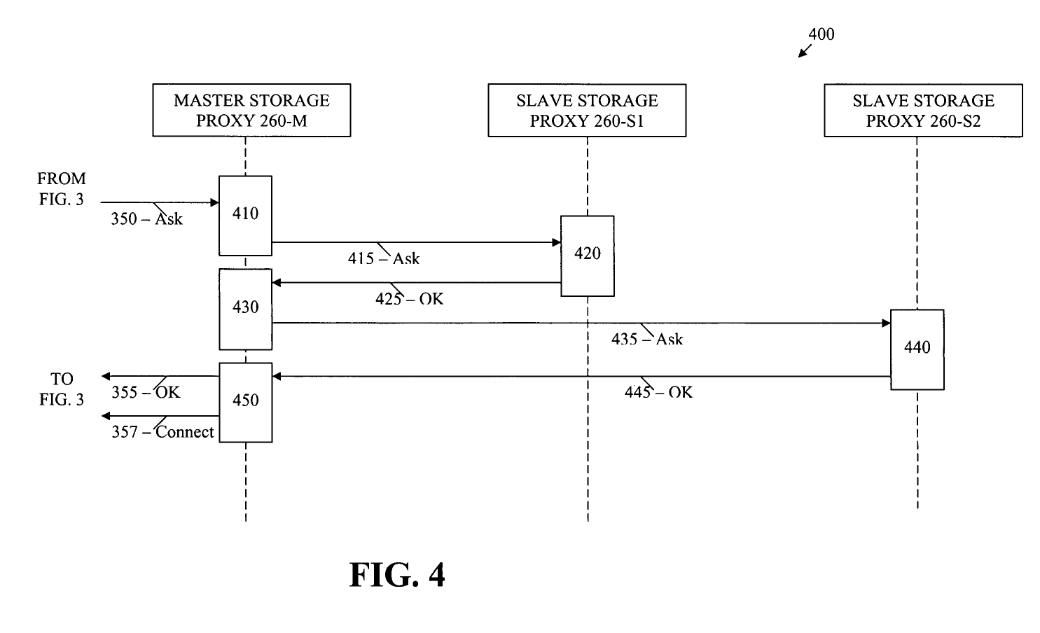

In the exemplary implementation shown in FIG. 2, the cooperative file distribution system 200 employs a master storage proxy 260-M and one or more additional slave storage proxies 260-S1 through 260-SN (collectively, referred to as slave storage proxies 260-S). As discussed below in conjunction with FIGS. 3 and 4, only the master storage proxy 260-M interacts with the sender 210 and the master storage proxy 260-M engages the necessary slave storage proxies 260-S and relays communications to such slave storage proxies 260-S.

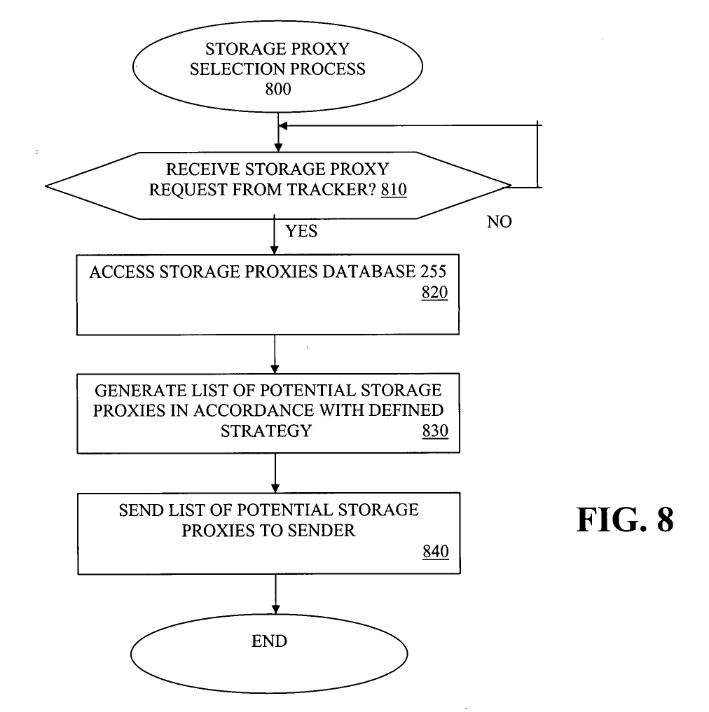

According to another aspect of the invention that ensures that the cached data remains persistent, data is written to the storage proxies 260 in such a manner that remaining nodes can recover the data if a predetermined number of storage proxies 260 become unavailable. In one exemplary implementation, data is written to three nodes, such that any two nodes can deliver the data. For example, if a first storage proxy 260 leaves the network, then one of the remaining storage proxies 260 (i) detects that the first storage proxy 260 is unavailable; (ii) requests a substitute storage proxy 260; and (iii) initiates a recreation of the data of the first storage proxy 260 by the substitute storage proxy 260. In this manner, the data is available as long as two of the storage proxies 260 remain available. In particular, the data can be recovered unless two of the three storage proxies 260 become unavailable faster than the data can be copied to a new node. Exemplary strategies for maintaining persistence of the storage proxies 260 are discussed below in conjunction with FIG. 8.

The cooperative file distribution system 200 may be implemented, for example, using the BitTorrent file distribution system 100 of FIG. 1, as modified herein to provide the features and functions of the present invention. As discussed hereinafter, the cooperative file distribution system 200 includes an offline tracker 230 that may be implemented using the tracker 130 of the BitTorrent file distribution system 100 of FIG. 1, as modified herein to provide the features and functions of the present invention.

In addition, as discussed further below in conjunction with FIG. 3, the cooperative file distribution 200 employs a proxy service 250 to identify potential nodes that are available to serve as storage proxies 260. The proxy service 250 may be integrated with the offline tracker 230, as shown in FIG. 2, or may be a stand-alone device, as would be apparent to a person of ordinary skill in the art. The proxy service 250 may employ, for example, a storage proxies database 255 that identifies the nodes that are available to serve as storage proxies 260. For each potential storage proxy 260, the exemplary storage proxies database 255 provides a measure of the idleness, available disk space, available bandwidth, and the likelihood that the node is online (e.g., a characterization of whether the node is transient or permanent). In addition, the storage proxies database 255 optionally provides information on the operating system employed by the node and the current IP address of the node. The storage proxies database 255 is optionally indexed by a global unique identifier (GUID), in a known manner.

The exemplary profile information maintained in the storage proxies database 255 may be obtained, for example, by a profile service that can be integrated with, or independent of, the proxy service 250. For example, the profile service may obtain information directly from each potential storage proxy 260 regarding the state of the node (e.g., whether the node is behind a firewall) and its resources. In addition, in a further variation, after a given receiver 220 has received a file or a portion thereof from a given storage proxy 260, the receiver 220 can provide a confirmation report to the profile service. In this manner, the validating information from the receivers 220 reduces the likelihood of abuse by the storage proxies 260.

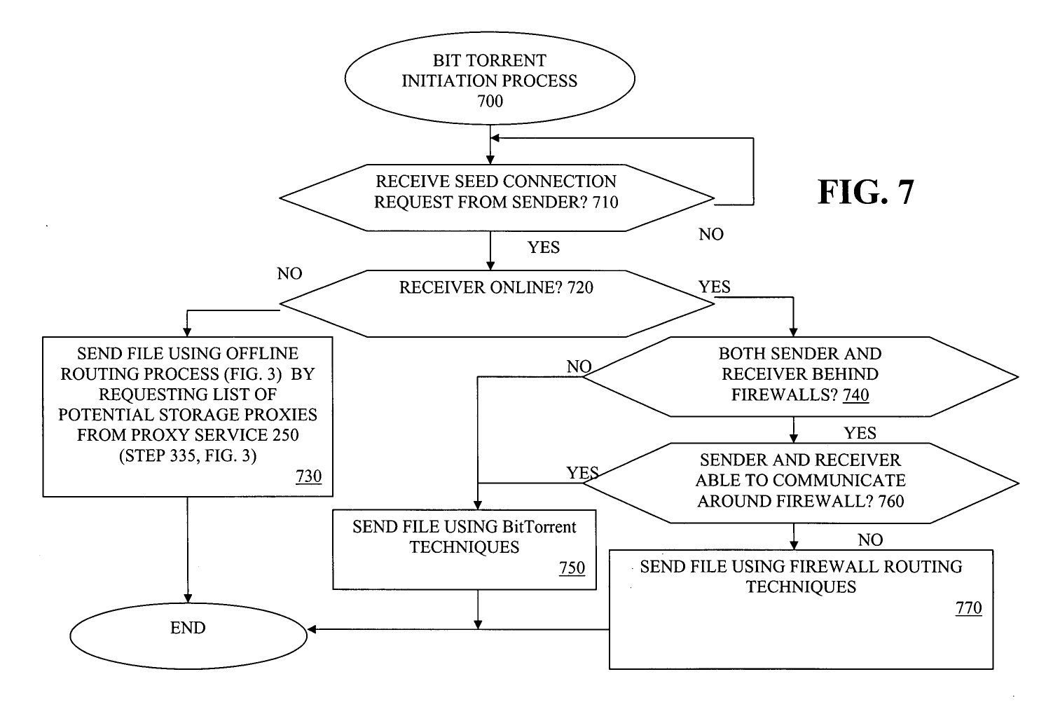

FIG. 3 is a communication sequence diagram 300 in accordance with a Unified Modeling Language (UML) notation, illustrating exemplary communications and other processing performed by the various entities of FIG. 2. As shown in FIG. 3, the communication sequence 300 is initiated during step 310 by the sender 210 connecting to the tracker 230 as a seed. Generally, the seed connection request 310 indicates to the tracker 230 that the sender has the complete file 205. The seed connection request 310 may be triggered, for example, by the sender's client upon attaching a document to an email or sending an email with an attachment. The seed connection request 310 is received by the tracker 230 and processed in a manner discussed further below in conjunction with FIG. 7.

In addition, the sender 210 sends an extended torrent file to the receiver 220 during step 315. Generally, the extended .torrent file is based on the torrent file 114 that contains information about the file, including its length, name, and hashing information for file validation, and the web address (e.g., a URL) of the tracker 230. The extended .torrent file also optionally contains an encryption key, and metadata, such as a preview and other file information. It is noted that each distinct file has a unique torrent identifier that is included in the .torrent file, for example, as an argument of the address of the tracker 230.

It is again noted that the present invention assumes that the receiver 220 is offline when the sender sends the extended torrent file. Upon receiving the seed connection request 310 from the sender 210, the offline tracker 230 will process the file transfer using a bit torrent initiation process 700, as discussed further below in conjunction with FIG. 7. Generally, the bit torrent initiation process 700 processes the seed connection request 310 from the sender 210 and determines how to best process the file transfer.

As shown in FIG. 3, if the communication sequence 300 resumes following execution of the bit torrent initiation process 700, the offline tracker 230 sends a request during step 335 to the proxy service 250 for a list of potential storage proxies 260.

Upon receipt of the storage proxy request 335, the proxy service 250 will initiate a storage proxy selection process 800, as discussed further below in conjunction with FIG. 8. Exemplary strategies for maintaining persistence of the storage proxies 260 are discussed below in conjunction with FIG. 8. Generally, the storage proxy selection process 800 generates a list of potential storage proxies based on one or more identified strategies for maintaining persistence of the storage proxies.

As shown in FIG. 3, the proxy service 250 sends the generated list of potential storage proxies to the sender 210 during step 340. The sender 210 processes the list of potential storage proxies during step 345 to obtain a master storage proxy 260-M. It is noted that the communication is only shown between the sender 210 and the master storage proxy 260-M, and that the additional communications between the master and slave storage proxies is discussed below in conjunction with FIG. 4. It is further noted that by having the sender 210 process the list of potential storage proxies during step 345, the load is reduced on the central offline tracker 230, allowing improved scaling as the number of users increases. If the sender 210 is unable to obtain a master storage proxy 260-M from the list of potential storage proxies provided during step 340, the sender can request another list of potential proxies from the proxy service 250.

Thus, the sender 210 sends an “ask” message to a potential master storage proxy 260-M during step 350, whereby the sender 210 asks the storage proxy to serve as a master storage proxy for a given piece of the file 205. The request contains an identifier of the torrent and file piece and the address of the offline tracker 230.

The “ask” message is received and processed by the potential master storage proxy 260 in a manner discussed further below in conjunction with FIG. 4. Generally, the potential storage proxy processes the “ask” request and determines whether to accept the request to serve as master and engage the necessary slave nodes. If the potential node can serve as the master storage proxy 260-M, the sender 210 will receive an acceptance message during step 355.

In addition, if the potential node can serve as the master storage proxy 260-M, the node 260-M will send a connect message to the offline tracker 230 during step 357 indicating that the node will serve as the master storage proxy 260-M for an identified piece of the torrent. The offline tracker 230 will process the connect message during step 362.

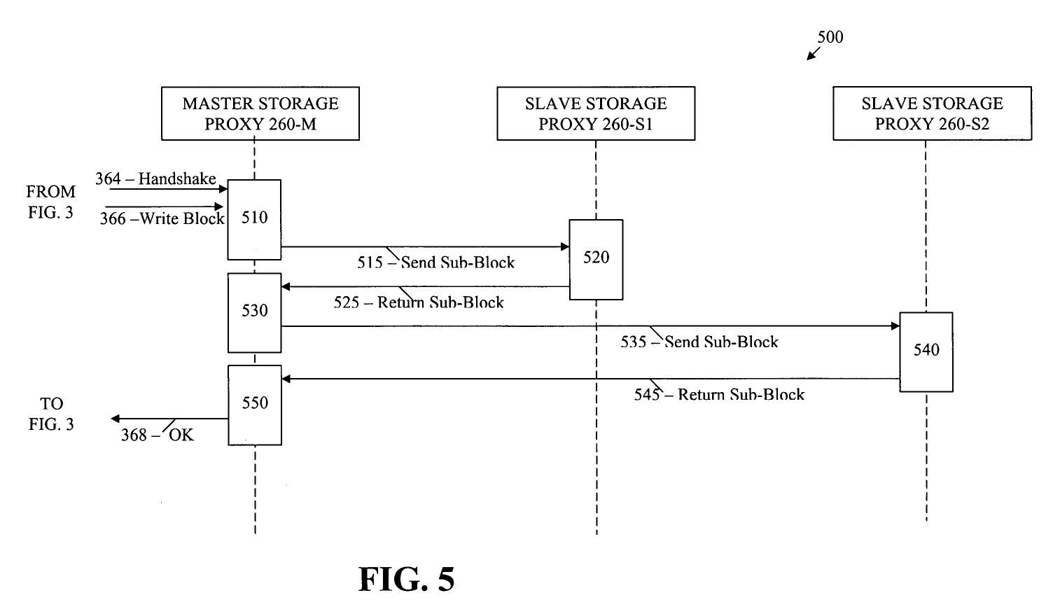

In response to receiving receive the acceptance message during step 355, the sender 210 will initiate a process 360 that processes the acceptance message 355 from the master proxy 260-M, and generates BitTorrent handshake and write block messages 364, 366, in a known manner, in order to negotiate and send the appropriate piece of the file 205 to the master storage proxy 260-M. In one exemplary implementation, the piece is encrypted using the key in the extended .torrent file to preserve the security of the file. It is noted that in most applications, encryption is preferable even though each storage proxy 260 typically only has access to a small portion of the file. In response to receiving the piece from the sender 210, the master storage proxy 260-M will initiate a process 500, discussed further below in conjunction with FIG. 5, to relay at least a portion of the received piece to one or more slave storage proxies 260-S. In addition, once the master storage proxy 260-M has validated the content, the master storage proxy 260-M sends a confirmation message during step 368 to the sender 210 indicating that the master storage proxy 260-M has successfully received the piece.

At some future point 370, shown in FIG. 3, the receiver 220 comes online again. When the receiver 220 comes online again, the receiver 220 will receive the extended torrent file (that was sent by the sender 210 at step 315). The receiver 220 receives and processes the extended .torrent file during step 372. Generally, during step 372, the receiver 220 clicks on the extended .torrent file, thereby launching a BitTorrent client and leech server 222 on the receiver 220. The leech server 222 sends a leech connection request to the offline tracker 230 during step 374.

The offline tracker 230 will process the leech connection request 374 during step 378 and notify the receiver 220 during step 380 that the requested file or portion thereof is being cached by a master storage proxy 260-M. Thus, the receiver 220 will send BitTorrent handshake and request piece messages 382, 384, in a known manner, in order to negotiate and obtain the appropriate piece of the file 205 from the master storage proxy 260-M.

The master storage proxy 260-M will process the request from the receiver 220 during step 386 and return the requested piece during step 390.

FIG. 4 is a communication sequence diagram 400 in accordance with UML notation, illustrating exemplary communications between the master storage proxy 260-M and one or more slave storage proxies 260-S. As shown in FIG. 4, the communication sequence 400 is initiated upon receipt of the “ask” message 350 by the potential master storage proxy 260. The master storage proxy 260-M will then send another ask message 415 to a first potential slave storage proxy 260-S1. The first potential slave storage proxy 260-S1 will determine whether to accept the position of a slave storage proxy for this communication, by evaluating predefined resource criteria. For example, one or more thresholds may be established that prevent a node from serving as a storage proxy if the node does not have sufficient available capacity or idle time, or the percentage of work being performed by the node for the cooperative file distribution system 200 exceeds a predefined threshold.

If the first potential slave storage proxy 260-S1 can serve as a storage proxy, an acceptance message is sent to the master storage proxy 260-M during step 425. Likewise, the master storage proxy 260-M continues the process during steps 430-445, sequentially engaging additional slave storage proxies 260-S, until the desired number of slave storage proxies 260-S have been engaged. FIG. 4 assumes that the cooperative file distribution system 200 employs one master storage proxy 260-M and two slave storage proxies 260-S1 and 260-S2.

Once the master storage proxy 260-M has engaged the appropriate number of slave storage proxies 260-S, the master storage proxy 260-M sends ok and connect messages 355, 357 to the sender 210 and offline tracker 230, respectively, and processing continues in the manner described above in conjunction with FIG. 3.

FIG. 5 is a communication sequence diagram 500 in accordance with UML notation, illustrating exemplary communications between the master storage proxy 260-M and one or more slave storage proxies 260-S for persistent storage of a file or a piece thereof. As shown in FIG. 5, the communication sequence 500 is initiated upon receipt of the BitTorrent handshake and write block messages 364, 366 (from FIG. 3). The master storage proxy 260-M will then send a sub-block of data to the first slave storage proxy 260-S1 during step 515. The first potential slave storage proxy 260-S1 will validate the received data and send a confirmation during step 525.

Likewise, the master storage proxy 260-M continues the process during steps 530-545, sequentially sending sub-blocks of data to each slave storage proxy 260-S, until each slave storage proxy 260-S has received and confirmed the appropriate data.

Once the master storage proxy 260-M has received the data confirmation 545 from the final slave storage proxy 260-S2, the master storage proxy 260-M sends an ok message 368 to the sender 210 and processing continues in the manner described above in conjunction with FIG. 3.

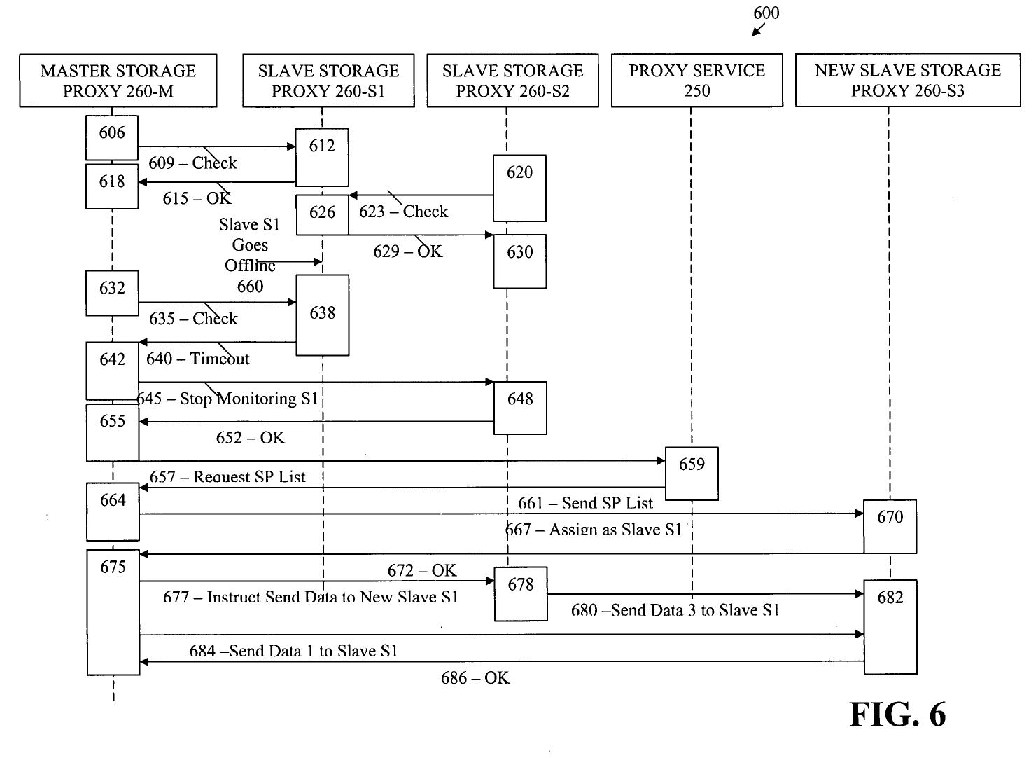

FIG. 6 is a communication sequence diagram 600 in accordance with UML notation, illustrating exemplary communications between the master storage proxy 260-M and one or more slave storage proxies 260-S for mutual monitoring and recreation of data in the event that one or more storage proxies 260 becomes unavailable. The communication sequence 600 may be executed, for example, continuously or at periodic intervals.

As shown in FIG. 6, the master storage proxy 260-M sends a check message 609 to the first slave storage proxy 260-S1 and receives an ok message 615 in return as long as the first slave storage proxy 260-S1 is active. In addition, the first slave storage proxy 260-S1 sends a check message 623 to the second slave storage proxy 260-S2 and receives an ok message 629 in return as long as the second slave storage proxy 260-S2 is active.

Assume that the first slave storage proxy 260-S1 goes offline at a time 660, as shown in FIG. 6. Thus, the next time that the master storage proxy 260-M sends a check message 635 to the first slave storage proxy 260-S1 and an ok message will not be received in return (since the first slave storage proxy 260-S1 is no longer active) and the message sequence will time-out at a time 640. In response to the time-out 640, the master storage proxy 260-M will instruct the second slave storage proxy 260-S2 to stop monitoring the first slave storage proxy 260-S1 during step 645, and the second slave storage proxy 260-S2 will acknowledge the message during step 652.

The master storage proxy 260-M will request a list of potential storage proxies during step 657 from the proxy service 250, and will receive the list 661 during step 664. The master storage proxy 260-M will then send an ask message 667 to another potential slave storage proxy 260-S3. The potential slave storage proxy 260-S3 will determine whether to accept the position of a slave storage proxy for this communication, by evaluating predefined resource criteria, in the manner discussed above in conjunction with FIG. 4. If the potential slave storage proxy 260-S3 can serve as a storage proxy, an acceptance message is sent to the master storage proxy 260-M during step 672.

Upon receiving the confirmation during step 675, the master storage proxy 260-M will send an instruction to the second slave proxy 260-S2 during step 677 to send its data to the new slave proxy 260-S3 and the second slave proxy 260-S2 will send its data to the new slave proxy 260-S3 during step 680. Meanwhile, the master storage proxy 260-M will send its data to the new slave proxy 260-S3 during step 684.

The new slave proxy 260-S3 will generate the data during step 682 that was previously stored by the first slave proxy 260-S1 from the data that is received from the master storage proxy 260-M and the second slave proxy 260-S2. The new slave proxy 260-S3 will send a message to the master storage proxy 260-M during step 686 confirming that the data of the first slave proxy 260-S1 has been validly regenerated by the new slave proxy 260-S3.

FIG. 7 is a flow chart describing an exemplary implementation of a bit torrent initiation process 700, as performed by the offline tracker 230. As indicated above and shown in FIG. 7, the bit torrent initiation process 700 is initiated during step 710 upon receipt of a seed connection request 310 from a sender 210. Upon receipt of the seed connection request 310, the bit torrent initiation process 700 determines if the receiver 220 is online during step 720. If it is determined during step 720 that the receiver 220 is not online, then the file is sent to the receiver 220 during step 730 using the offline routing techniques of the present invention, as discussed above in conjunction with FIG. 3, by sending a request to the proxy service 250 for a list of potential storage proxies. Generally, the offline routing techniques of the present invention assume that the receiver 220 is offline.

If, however, it is determined during step 720 that the receiver 220 is online, then a further test is performed during step 740 to determine if the sender 210 and receiver 220 are both behind firewalls. If it is determined during step 730 that at least one of the sender 210 and receiver 220 are not behind a firewall, then the sender 210 and receiver 220 can communicate directly, and the file may be shared during step 750 using conventional BitTorrent techniques.

If, however, it is determined during step 740 that the sender 210 and receiver 220 are both behind firewalls, then a further test is performed during step 760 to determine if the sender 210 and receiver 220 can communicate around the firewall(s) (also shown as step 330 in FIG. 3), for example, using known User Datagram Protocol (UDP) hole punching techniques. If it is determined during step 760 that the sender 210 and receiver 220 can communicate around the firewall(s), then the sender 210 and receiver 220 can communicate directly, and the file may be shared during step 750 using conventional BitTorrent techniques.

If, however, it is determined during step 760 that the sender 210 and receiver 220 cannot communicate around the firewall(s), then the file is sent during step 770 using firewall routing techniques, as described in U.S. patent application Ser. No. ______, filed contemporaneously herewith and entitled “Method and Apparatus for Cooperative File Distribution in the Presence of Firewalls.”

FIG. 8 is a flow chart describing an exemplary implementation of a storage proxy selection process 800, as performed by the proxy service 250. As indicated above and shown in FIG. 8, the storage proxy selection process 800 is initiated during step 810 upon receipt of a storage proxy request 335 from the offline tracker 230.

The storage proxy selection process 800 accesses the storage proxies database 255 during step 820 to generate a list of potential storage proxies 260 during step 830. The generated list is then sent to the sender 210 during step 840 (corresponds to step 340 in FIG. 3). The storage proxy selection process 800 selects potential storage proxies 260 in accordance with a predefined strategy for maintaining persistence, discussed below. Generally, storage proxies 260 are selected that are not behind a firewall, and satisfy one or more resource criteria, such as having generally high measures for idleness, available disk space, available bandwidth, and the likelihood that the node is online.

For example, a cooperative file distribution system 200 employing three storage proxies 260 can adopt one of the following exemplary predefined strategies for maintaining persistence of the storage proxies 260:

1) the files are written to a number of storage proxies 260 using an encoding scheme that provides redundancy, such as Reed Solomon encoding, whereby each storage proxy 260 stores a portion of the overall file (or file piece) and the entire file 205 (or portion thereof) can be obtained from less than all of the storage proxies 260 (in a further variation, even/odd/exclusive or (XOR) encoding is employed whereby a first node stores all even bits, a second node stores all odd bits and a third nodes stores the XOR of the even and odd bits);

2) storage proxies 260 watch each other and data is written to the storage proxies 260 in such a way that if one storage proxy 260 becomes unavailable it can be detected by the remaining storage proxies 260 and the associated data can be recreated on a substitute storage proxy 260; and

3) each storage proxy 260 stores the entire file 205 and watches the other storage proxies 260 (although bandwidth inefficient, this strategy provides the most resilience).

### System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A cooperative method for transferring a file from a sender to a receiver, comprising the steps of:
receiving an indication from said sender that said sender has said file;
determining if said receiver is online; and
initiating a storage of said file on one or more storage proxies if said receiver is not online.

2. The method of claim 1, wherein a plurality of said storage proxies monitor one another to determine if at least one storage proxy goes offline.

3. The method of claim 2, wherein one or more of said storage proxies recreate the data stored by a storage proxy that has gone offline.

4. The method of claim 1, wherein said file is stored on said one or more storage proxies such that said file can be recovered if one or more of said storage proxies becomes unavailable.

5. The method of claim 5, wherein each of said one or more storage proxies store a complete copy of said file.

6. The method of claim 5, wherein a plurality of said storage proxies store a portion of said file using an encoding technique that allows said file to be recovered if one or more of said storage proxies becomes unavailable.

7. The method of claim 1, wherein said one or more of said storage proxies are selected that have a likelihood measure for remaining online that exceeds a predefined threshold.

8. A cooperative method for transferring a file from a sender to a receiver, comprising the steps of:
receiving an indication from said sender that said sender has said file;
determining if said receiver is online;
obtaining a list of potential storage proxies for transferring said file from said sender to said receiver if said receiver is not online; and
initiating a transfer of said file from said sender to said receiver using one or more of said potential storage proxies.

9. The method of claim 8, wherein each of said storage proxies on said potential list of storage proxies satisfy one or more predefined resource criteria.

10. The method of claim 8, further comprising the step of determining if one or more of said storage proxies on said potential list of storage proxies agree to serve as a storage proxy.

11. The method of claim 10, wherein a given storage proxy determines whether to serve as a storage proxy for a given communication by comparing one or more resource measures to predefined criteria.

12. The method of claim 10, wherein a first storage proxy agrees to serve as a master storage proxy and engages one or more additional slave storage proxies.

13. A cooperative method for sending a file from a sender to a receiver, comprising the steps of:
sending an indication to a central tracker that said sender has said file;
receiving a list of potential storage proxies for storing said file while said receiver is unavailable;
sending a request to one or more of said storage proxies from said list of storage proxies to act as a storage proxy between said sender and said receiver; and
transferring said file to said one or more of said potential storage proxies.

14. The method of claim 13, wherein a given storage proxy determines whether to serve as a storage proxy for a given communication by comparing one or more resource measures to predefined criteria.

15. A method for identifying one or more storage proxies for transferring a file from a sender to a receiver, comprising the steps of:
identifying one or more storage proxies that can store said file while said receiver is unavailable and satisfy one or more predefined resource criteria; and
providing a list of potential storage proxies for transferring said file from said sender to said receiver.

16. The method of claim 15, wherein said predefined resource criteria evaluates measures for one or more of idleness, disk space, bandwidth, and network persistence.

17. The method of claim 15, further comprising the step of determining if one or more of said storage proxies on said potential list of storage proxies agree to serve as a storage proxy.

18. The method of claim 15, wherein a given storage proxy determines whether to serve as a storage proxy for a given communication by comparing one or more resource measures to predefined criteria.

19. The method of claim 15, wherein a first storage proxy agrees to serve as a master storage proxy and engages one or more additional slave storage proxies.

20. A cooperative method for sending a file from a sender to a receiver, comprising the steps of:
receiving a request to act as a storage proxy for storing said file while said receiver is unavailable;
comparing one or more resource measures to predefined criteria; and
providing an acceptance if said one or more resource measures satisfy said predefined criteria.

21. The method of claim 20, wherein said resource measures include one or more of capacity, idle time, or a percentage of work being performed as a storage proxy for other communications.

22. The method of claim 20, wherein said request is to act as a master storage proxy and to engage one or more additional slave storage proxies.

23. A cooperative method performed by a receiver for receiving a file from a sender, comprising the steps of:
sending a connection message to a central tracker to obtain said file;
receiving a notification of one or more storage proxies that stored at least a portion of said file while said receiver was unavailable; and
obtaining said at least a portion of said file from said one or more storage proxies.

24. The method of claim 23, wherein said obtaining step further comprises the step of employing a handshake communication.

25. A cooperative system for transferring a file from a sender to a receiver, comprising:
a memory; and
at least one processor, coupled to the memory, operative to:
receive an indication from said sender that said sender has said file;
determine if said receiver is online; and
initiate a storage of said file on one or more storage proxies if said receiver is not online.

26. A cooperative system for transferring a file from a sender to a receiver, comprising:
a memory; and
at least one processor, coupled to the memory, operative to:
receive an indication from said sender that said sender has said file;
determine if said receiver is online;
obtain a list of potential storage proxies for transferring said file from said sender to said receiver if said receiver is not online; and
initiate a transfer of said file from said sender to said receiver using one or more of said potential storage proxies.

27. A cooperative system for sending a file from a sender to a receiver, comprising:
a memory; and
at least one processor, coupled to the memory, operative to:
send an indication to a central tracker that said sender has said file;
receive a list of potential storage proxies for storing said file while said receiver is unavailable;
send a request to one or more of said storage proxies from said list of storage proxies to act as a storage proxy between said sender and said receiver; and
transfer said file to said one or more of said potential storage proxies.

28. A system for identifying one or more storage proxies for transferring a file from a sender to a receiver, comprising:
a memory; and
at least one processor, coupled to the memory, operative to:
identify one or more storage proxies that can store said file while said receiver is unavailable and satisfy one or more predefined resource criteria; and
provide a list of potential storage proxies for transferring said file from said sender to said receiver.

29. A cooperative system for sending a file from a sender to a receiver, comprising:
a memory; and
at least one processor, coupled to the memory, operative to:
receive a request to act as a storage proxy for storing said file while said receiver is unavailable;
compare one or more resource measures to predefined criteria; and
provide an acceptance if said one or more resource measures satisfy said predefined criteria.

30. A cooperative system for receiving a file from a sender, comprising:
a memory; and
at least one processor, coupled to the memory, operative to:
send a connection message to a central tracker to obtain said file;
receive a notification of one or more storage proxies that stored at least a portion of said file while said receiver was unavailable; and
obtain said at least a portion of said file from said one or more storage proxies.
